(19) United States
(12) Patent Application Publication
(10) Pub. No.: US 2026/0021700 A1
(43) Pub. Date: Jan. 22, 2026

(54) VEHICLE DISPLAY CONTROL DEVICE, VEHICLE DISPLAY CONTROL METHOD, AND STORAGE MEDIUM STORING PROGRAM

(71) Applicant: TOYOTA JIDOSHA KABUSHIKI KAISHA, Toyota-shi (JP)

(72) Inventor: Miki TSUJINO, Ichinomiya-shi (JP)

(73) Assignee: TOYOTA JIDOSHA KABUSHIKI KAISHA, Toyota-shi (JP)

(21) Appl. No.: 19/228,108

(22) Filed: Jun. 4, 2025

(30) Foreign Application Priority Data
Jul. 16, 2024 (JP) 2024-113569

(51) Int. Cl. B60K 35/28; B60K 35/231

(52) U.S. Cl. CPC B60K 35/28; B60K 35/231; B60K 2360/162; B60K 2360/167; B60K 2360/171

(57) ABSTRACT

A vehicle display control device that is configured to: display an ego vehicle image depicting an ego vehicle, and a function image indicating an action function of the ego vehicle, on a display region provided at a periphery of a driver's seat of the ego vehicle, and display the function image in a region at a periphery of the ego vehicle image so as to move based on a change to a state of the action function.

### CROSS-REFERENCE TO RELATED APPLICATION

This application is based on and claims priority under 35 USC 119 from Japanese Patent Application, No. 2024-113569 filed on Jul. 16, 2024, the disclosure of which is incorporated by reference herein in its entirely.

### BACKGROUND

### Technical Field

Technology disclosed herein relates to a vehicle display control device, a vehicle display control method, and a storage medium storing a vehicle display control program.

### Related Art

A vehicle control device capable of performing automatic driving that imparts a sense of security to an occupant is disclosed in Japanese Patent No. 7048398. This vehicle control device includes a display part that displays an image, a recognition part that recognizes objects including another vehicle, a drive control part that generates a target track of an ego vehicle based on the state of the object, and controls at least one of speed or steering of the ego vehicle based on the target track, and a display control part that causes a first image formed to imitate the other vehicle, and a second image formed to imitate the target track, to be displayed on the display part superimposed on a third image formed to imitate a road where the ego vehicle is present. The second image is an image in which, among plural segments obtained by partitioning the target track with respect to the length direction, a first segment is displayed with more emphasis compared to a second segment. When viewed from the ego vehicle, the first segment is further to a near side than a reference vehicle referenced when the target track is generated, and the second segment is further to a far side when viewed from the ego vehicle than the reference vehicle.

In the technology described in Japanese Patent No. 7048398, recognized conditions in the surroundings of the ego vehicle, and the target track of the ego vehicle, are both displayed, with this leading to a concern that the occupant may not be able to be made sufficiently aware of changes to a state of an action function of the ego vehicle (for example, a driving assistance function, a warning function, or the like).

### SUMMARY

An aspect of the present disclosure is a vehicle display control device that includes: a memory, and a processor coupled with the memory, the processor being configured to: display an ego vehicle image depicting an ego vehicle, and a function image indicating an action function of the ego vehicle, on a display region provided at a periphery of a driver's seat of the ego vehicle, and display the function image in a region at a periphery of the ego vehicle image so as to move based on a change to a state of the action function.

### BRIEF DESCRIPTION OF THE DRAWINGS

Exemplary embodiments of technology disclosed herein will be described in detail based on the following figures, wherein:

FIG. 1 is a schematic diagram schematically illustrating a state of a vehicle cabin front section of a vehicle according to a first exemplary embodiment, as viewed from a vehicle rear side;

FIG. 2 is a block diagram illustrating a hardware configuration of a vehicle display control device according to the first exemplary embodiment;

FIG. 3 is a block diagram illustrating a functional configuration of a vehicle display control device according to the first exemplary embodiment;

FIG. 4A is a diagram illustrating an example of a display screen of a second display unit according to the first exemplary embodiment;

FIG. 4B is a diagram illustrating an example of a display screen of a second display unit according to the first exemplary embodiment;

FIG. 4C is a diagram illustrating an example of a display screen of a second display unit according to the first exemplary embodiment;

FIG. 4D is a diagram illustrating an example of a display screen of a second display unit according to the first exemplary embodiment;

FIG. 5 is a flowchart illustrating an example of a flow of display processing according to the first exemplary embodiment;

FIG. 6A is a diagram illustrating an example of a display screen of a second display unit according to a second exemplary embodiment;

FIG. 6B is a diagram illustrating an example of a display screen of a second display unit according to the second exemplary embodiment;

FIG. 6C is a diagram illustrating an example of a display screen of a second display unit according to the second exemplary embodiment;

FIG. 6D is a diagram illustrating an example of a display screen of a second display unit according to the second exemplary embodiment;

FIG. 7 is a flowchart illustrating an example of a flow of display processing according to the second exemplary embodiment;

FIG. 8 is a diagram illustrating an example of a display screen of a second display unit according to another exemplary embodiment;

FIG. 9A is a diagram illustrating an example of a display screen of a second display unit according to another exemplary embodiment; and

FIG. 9B is a diagram illustrating an example of a display screen of a second display unit according to another exemplary embodiment.

### DETAILED DESCRIPTION

### First Exemplary Embodiment

Description follows regarding a vehicle 12 applied with a vehicle display control device 10 according to a first exemplary embodiment, with reference to the drawings. Note that the vehicle 12 of the present exemplary embodiment includes, as an example, plural driving assistance functions including a driving assistance function related to automatic driving. The vehicle 12 is an example of an “ego vehicle”. The driving assistance functions are each an example of an “action function”.

Although various driving assistance functions are included in the driving assistance functions provided to the vehicle 12 of the present exemplary embodiment, description follows regarding the following driving assistance functions as examples in the present exemplary embodiment.
(1) Radar Cruise Control (Adaptive Cruise Control/Dynamic Radar Cruise Control (ACC/DRCC). This function is a driving assistance function to assist following travel while maintaining an inter-vehicle distance according to vehicle speed by recognizing a vehicle ahead using a camera and radar (single lens reflex camera and millimeter wave radar) contained in a sensor group 42, described later.
(2) Lane Departure Alert (LDA). This function prompts a driver to perform a departure avoidance maneuver by notification using a display and buzzer, or steering wheel vibration, when a system has determined a possibility of the vehicle departing from its lane. This function also assists suppression of lane departure by adding a steering force to steering and by display.
(3) Lane Tracing Assist (LTA). This function assists in a system to produce part of steering force needed to enable travel along the center of the same vehicle lane during ACC. The usage scenario thereof is, for example, during travel on an expressway.

### Vehicle Cabin Interior of Vehicle 12

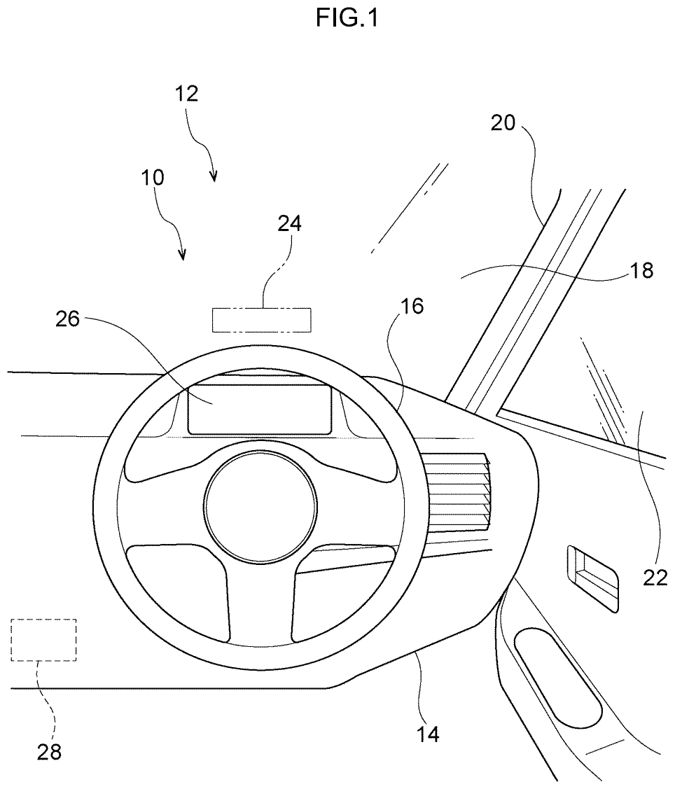

As illustrated in FIG. 1, an instrument panel 14 is installed in a vehicle cabin front section of the vehicle 12. The instrument panel 14 extends in the vehicle width direction, and a steering wheel 16 is provided at a vehicle right side of the instrument panel 14. Namely, in the present exemplary embodiment, as an example, the driver's seat is installed at the vehicle right side of a right-hand drive car having the steering wheel 16 installed on the right side.

A windshield glass 18 is provided at a front-end section of the instrument panel 14. The windshield glass 18 extends substantially in the vehicle height direction and the vehicle width direction, and partitions between the vehicle cabin interior and the vehicle cabin exterior.

The vehicle right side end portion of the windshield glass 18 is fixed to a vehicle right side front pillar 20. The front pillar 20 extends substantially in the vehicle height direction, and the windshield glass 18 is fixed to the vehicle width direction inside end portion of the front pillar 20. A front end portion of a front side glass 22 is fixed to a vehicle width direction outside end portion of the front pillar 20. Note that the vehicle left side end portion of the windshield glass 18 is fixed to a vehicle left side front pillar.

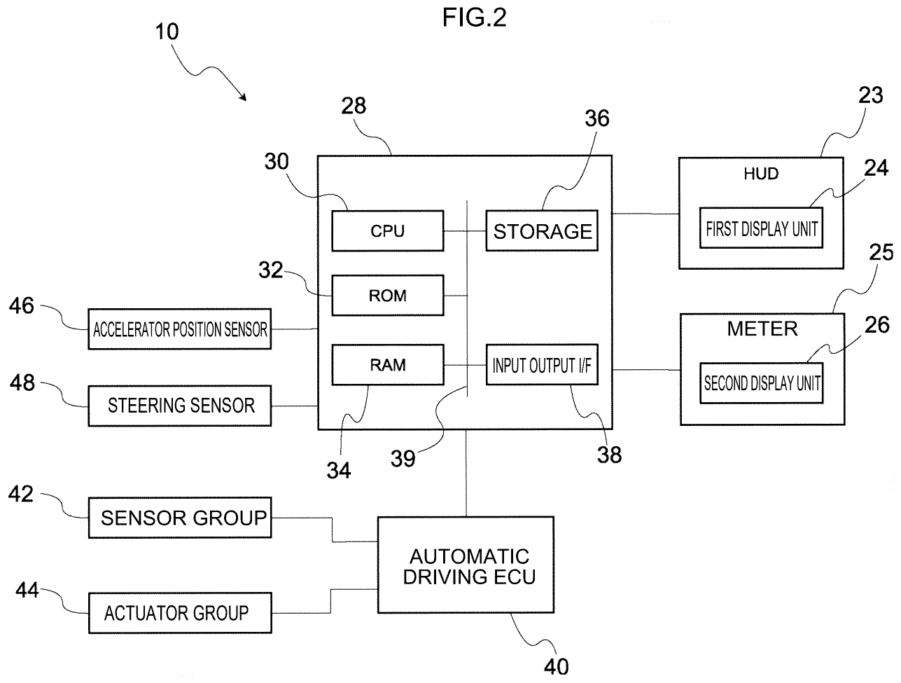

A first display unit 24 is provided to the windshield glass 18. The first display unit 24 is configured by a projection surface projected onto by a head-up display device 23 illustrated in FIG. 2. More specifically, the head-up display device 23 is provided further to the vehicle front side than the instrument panel 14, and is configured such that footage from the head-up display device 23 is projected toward the first display unit 24 of the windshield glass 18.

A second display unit 26 is provided further to the vehicle lower side than the first display unit 24. The second display unit 26 is a display unit displayed with meters 25, with the meters 25 being positioned on the instrument panel 14 at the vehicle front side of the driver's seat. The first display unit 24 and the second display unit 26 are provided at positions visible by the driver. A vehicle display system is configured by the vehicle display control device 10, the first display unit 24, and the second display unit 26.

### Vehicle Display Control Device 10 Hardware Configuration

As illustrated in FIG. 2, the vehicle display control device 10 of the first exemplary embodiment is configured including an electronic control unit (ECU) 28.

The ECU 28 is configured including a central processing unit (CPU) 30, read only memory (ROM) 32, random access memory (RAM) 34, storage 36, and an input-output interface (I/F) 38. Each configuration is connected together through a bus 39 so as to be capable of communicating with each other.

The CPU 30 is an example of a hardware processor, and is a central processing unit that executes various programs and controls each section. Namely, the CPU 30 reads a program from the ROM 32 or the storage 36, and executes the program using the RAM 34 as a work area. The CPU 30 controls each of the above configuration and performs various computational processing according to the program recorded on the ROM 32 or the storage 36.

The ROM 32 is stored with various programs and various data. The RAM 34 serves as a work arca temporarily stored with programs or data. The storage 36 is configured by a hard disk drive (HDD) or a solid state drive (SSD), and is a non-transitory recording medium stored with various programs including an operating system and various data. In the present exemplary embodiment, the ROM 32 or the storage 36 correspond to memory, and are stored with a display program and the like for performing display processing. Moreover, various input-output devices are connected to the input-output interface 38.

The ECU 28 is electrically connected to an automatic driving ECU 40. The automatic driving ECU 40 is, similarly to the ECU 28, configured including a CPU, ROM, RAM, storage, input-output interface, and the like.

The sensor group 42 for detecting current conditions of the vehicle and an actuator group 44 for controlling vehicle travel are connected to the automatic driving ECU 40. Plural sensors are included in the sensor group 42 from out of various sensors such as a camera, a radar, light detection and ranging/laser imaging detection and ranging (LIDAR), a global positioning system (GPS) sensor, and the like. The camera captures images of the surroundings of the vehicle. The radar uses radio waves to detect distances and directions to objects in the surroundings of the vehicle. The LIDAR uses laser light to detect distances and directions to objects in the surroundings of the vehicle. The GPS sensor detects the current position of the vehicle. In addition, the sensor group 42 is also configured including a sensor for detecting a state of an occupant. For example, the sensor group 42 may be configured including a biometric sensor to detect a heart rate, degree of arousal, and the like of the occupant.

The actuator group 44 includes an acceleration-deceleration actuator for adjusting vehicle acceleration-deceleration and a steering actuator for driving a vehicle steering device. Automatic driving of the vehicle is performed in the automatic driving ECU 40 by controlling actions of the actuator group 44 according to the current condition of the vehicle as detected by the sensor group 42. Note that a scheduled route representing a route scheduled for vehicle travel is stored in a storage section of the automatic driving ECU 40, and the automatic driving ECU 40 causes the vehicle to travel along the scheduled route stored in the storage section.

An accelerator position sensor 46 and a steering sensor 48 are connected to the ECU 28. The accelerator position sensor 46 is a sensor for detecting a position of an accelerator pedal provided at a portion in front of and below the driver's seat. Moreover, the steering sensor 48 is a sensor for detecting load applied to the steering wheel 16 by the occupant. Namely, the steering sensor 48 of the present exemplary embodiment is configured so as not to detect load when the steering wheel 16 is being operated by the automatic driving ECU 40 during automatic driving, but to detect load when the steering wheel 16 is being operated by the occupant.

### Vehicle Display Control Device 10 Functional Configuration

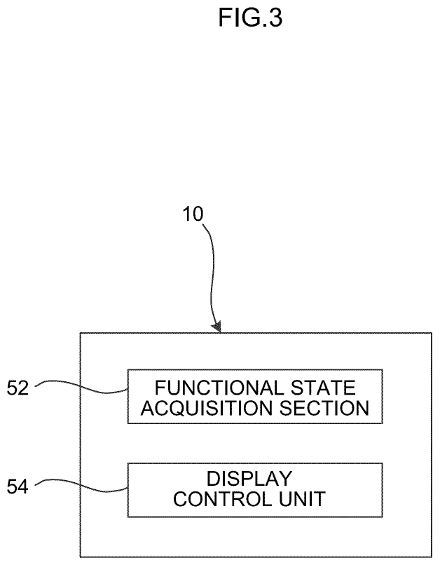

The vehicle display control device 10 implements various functions using the above hardware resources. Description follows regarding functional configuration implemented by the vehicle display control device 10, with reference to FIG. 3.

As illustrated in FIG. 3, the vehicle display control device 10 of the first exemplary embodiment is configured including, as functional configuration, a functional state acquisition section 52 and a display control unit 54. Each of the functional configuration is implemented by the CPU 30 of the ECU 28 reading and executing a program.

The functional state acquisition section 52 includes a function to acquire an action state of a driving assistance function of the vehicle 12. The functional state acquisition section 52 acquires, for example, information related to an action state of the driving assistance function of the vehicle 12 based on a signal from the automatic driving ECU 40. The action states include, more precisely, states such as a stopped state that is a state in which a function is not activated, a standby state that is a state in which function activation is enabled, an activated state that is a state in which the function is being activated, an abnormal state that is a state in which an action of the function is being impeded, and the like. The standby state is an example of a “case in which an action function is unavailable”. The activated state is an example of a “case in which an action function is enabled”.

The functional state acquisition section 52 also includes a function to detect when the action state of the driving assistance function of the vehicle 12 has been changed. The functional state acquisition section 52 acquires, for example, information related to a change in the action state of the driving assistance function of the vehicle 12 based on signals from the automatic driving ECU 40.

The display control unit 54 includes a function to display the action state of the driving assistance function of the vehicle 12 on the first display unit 24 and the second display unit 26 provided inside the vehicle cabin. The display control unit 54, more specifically, displays a tell-tale indicating an action state of a driving assistance function of the vehicle 12 on the first display unit 24 and the second display unit 26, with a display changed according to the action state acquired by the functional state acquisition section 52. Note that the tell-tale displayed changed by the display control unit 54 may be at least one tell-tale. The tell-tale indicting the action state of the driving assistance function is an example of a “function image”.

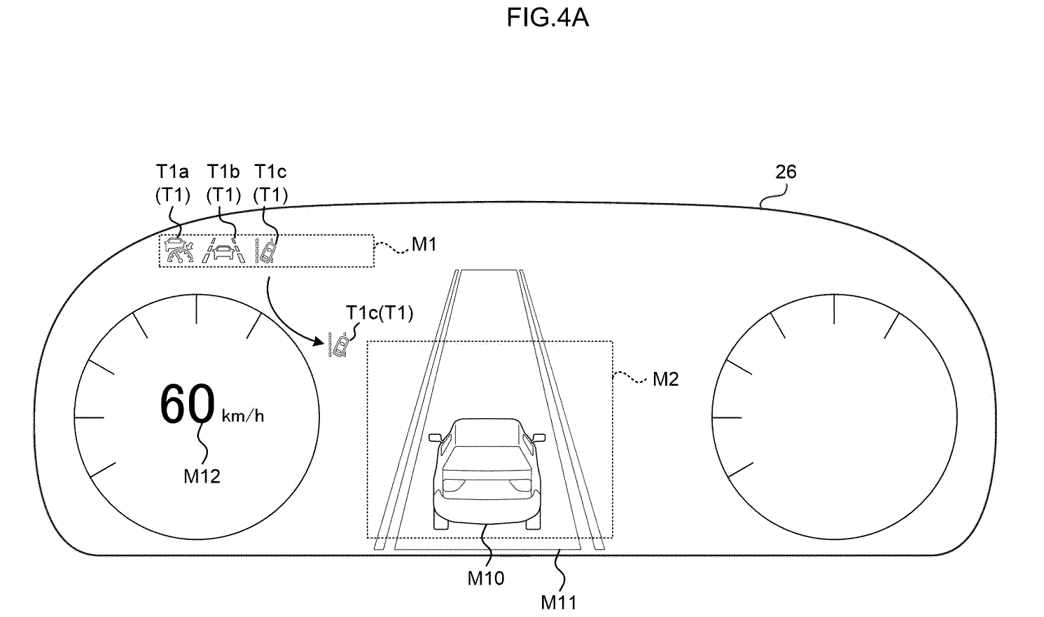

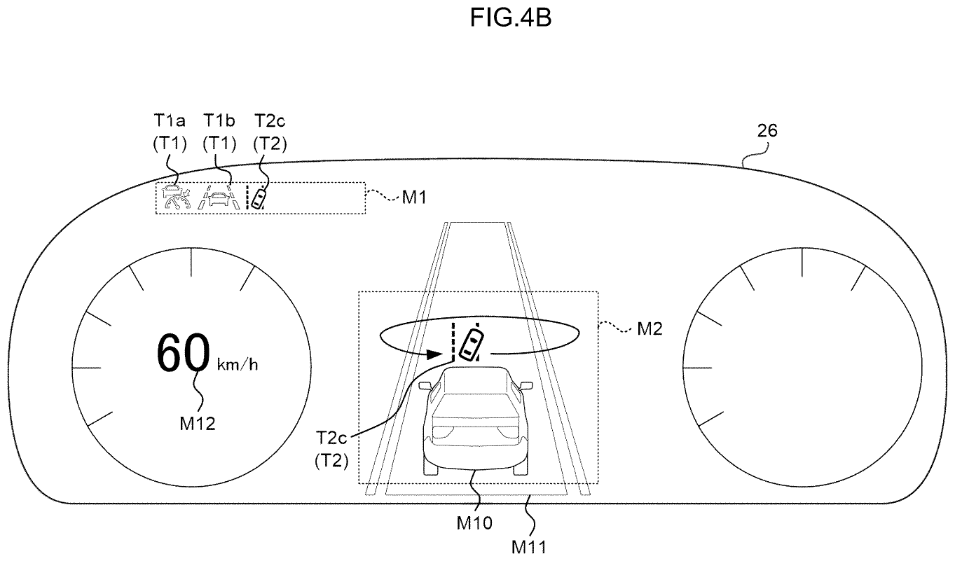

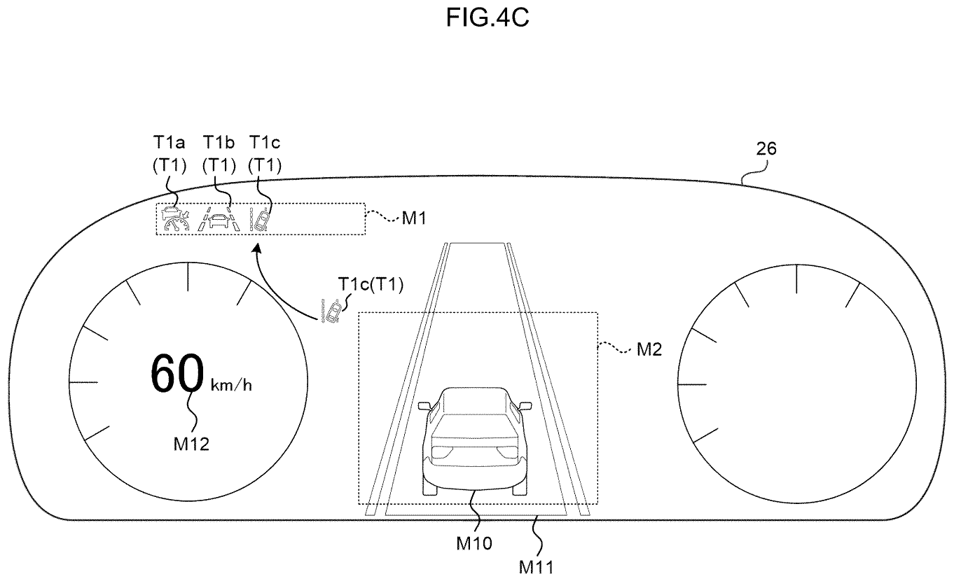

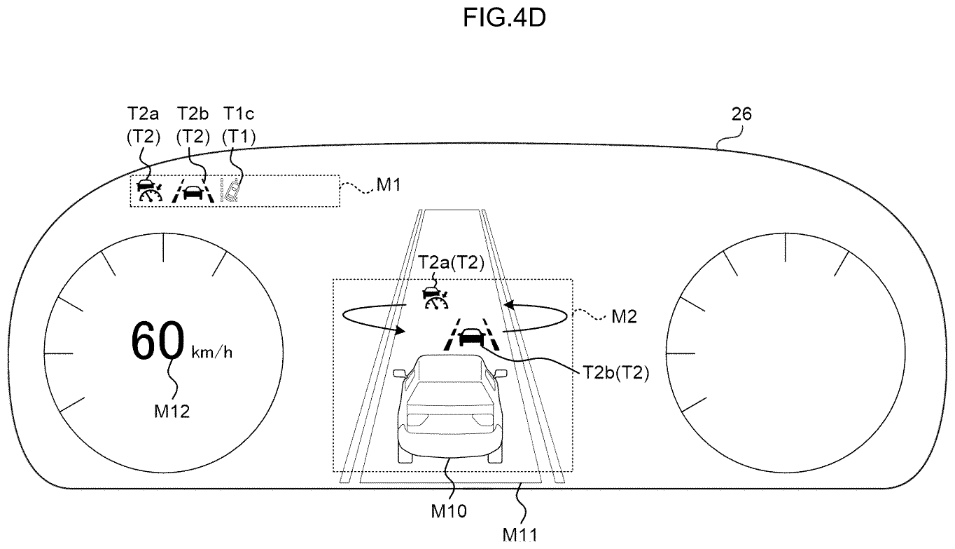

The display control unit 54 of the present exemplary embodiment displays so as to move the tell-tale indicating a driving assistance function of the vehicle 12 according to the action state of this driving assistance function. Specifically, when the driving assistance function of the vehicle 12 has changed from being in a standby state to being in an activated state, the display control unit 54 displays so as to move the tell-tale indicating this driving assistance function from a fixed displayable region to a region in a vicinity of an ego vehicle image M10 depicting the vehicle 12 (see FIG. 4A). Moreover, when a driving assistance function has changed from the activated state to the standby state, the display control unit 54 displays so as to move the tell-tale indicating this driving assistance function from the region in the vicinity of the ego vehicle image M10 to the fixed displayable region. The display control unit 54 continues to display the tell-tale indicating this driving assistance function in the region in the vicinity of the ego vehicle image while the driving assistance function is in the activated state. Note that the region in the vicinity of the ego vehicle image M10 is, for example, a region inside a pre-set range from the ego vehicle image M10. The fixed displayable region and the region in the vicinity of the ego vehicle image are examples of a “region at a periphery of the ego vehicle image”.

The display control unit 54 of the present exemplary embodiment displays a mode of the tell-tale indicating this driving assistance function changed according to the action state of the driving assistance function of the vehicle 12. More specifically, as a change of the mode, the display control unit 54 displays the tell-tale emphasized according to the action state of the driving assistance function. “Emphasized display” of the tell-tale encompasses raising the luminance, changing the color (namely the brightness, chroma, hue, or the like), or the like. The display control unit 54, as an example, displays the tell-tale in white when the driving assistance function is in the activated state, and displays the tell-tale in gray when the driving assistance function is in the standby state. Note that the display control unit 54 may be configured so as to display the tell-tale in green when the driving assistance function is in the activated state, and display the tell-tale in white when the driving assistance function is in the standby state. Moreover, the display control unit 54 may be configured so as to display the tell-tale in gray when the driving assistance function is in the stopped state, and display the tell-tale in amber when the driving assistance function is in the abnormal state.

### Display Screen

Description follows regarding part of a display screen displayed in a display region on the second display unit 26 of the first exemplary embodiment, with reference to FIG. 4A to FIG. 4D. FIG. 4A to FIG. 4D are diagrams illustrating a tell-tale being displayed with a display changed according to the action state of the driving assistance function of the vehicle 12. The display region on the second display unit 26 is an example of a “display region”.

As illustrated in FIG. 4A to FIG. 4D, the ego vehicle image M10 depicting the vehicle 12, a road surface image M11 depicting a cruising lane of the vehicle 12, and a speed display M12 indicating a speed of the vehicle 12, are displayed on the second display unit 26. Moreover, standby tell-tales T1 and activated tell-tales T2 are tell-tales indicating action states of the driving assistance function displayed on the second display unit 26. The second display unit 26A is set with a fixed display region M1 where the standby tell-tale T1 is displayable fixed, and an ego vehicle region M2 where the activated tell-tale T2 is displayable. The fixed display region M1 is an example of a “first region”. The ego vehicle region M2 is an example of a “second region”.

The ego vehicle image M10 is displayed superimposed on the road surface image M11 at a central lower portion position of the display region on the second display unit 26. Moreover, the speed display M12 is displayed at a height direction substantially central position at the left of the ego vehicle image M10. Left and right directions in the present exemplary embodiment are left and right direction of the display region of the second display unit 26, and align with the left and right directions with respect to the direction of travel of the vehicle 12. The height direction is the height direction of the display region of the second display unit 26.

The standby tell-tales T1 are tell-tales indicating the standby state. Moreover, the standby tell-tales T1 are displayed so as to move between the fixed display region M1 and the ego vehicle region M2 when the action state of the driving assistance function has changed. The standby tell-tales T1 of the present exemplary embodiment include a standby tell-tale T1a indicating that ACC is in the standby state, a standby tell-tale T1b indicating that the LTA is in a standby state, and a standby tell-tale T1c indicating that the LDA is in a standby state.

The activated tell-tales T2 are tell-tales indicating the activated state, and are displayed emphasized compared to the standby tell-tales T1. Moreover, the activated tell-tales T2 are displayed above the ego vehicle image M10 of the ego vehicle region M2 so as to loop counterclockwise from the near side to the far side. Reference here to the “near side” means at the rear side of the vehicle indicated by the ego vehicle image M10 and matches downward on the second display unit 26. Moreover, reference to the “far side” means at the front side of the vehicle indicated by the ego vehicle image M10 and matches upward on the second display unit 26. Note that the activated tell-tales T2 of the present exemplary embodiment are displayed larger the more they are being displayed toward the near side, and are displayed smaller the more they are being displayed toward the far side. The activated tell-tales T2 of the present exemplary embodiment include an activated tell-tale T2a indicating that the ACC is in the activated state, an activated tell-tale T2b indicating the that LTA is in the activated state, and an activated tell-tale T2c indicating that the LDA is in the activated state.

The fixed display region M1 is a region where the standby tell-tale T1 and the activated tell-tale T2 are displayable fixed in a row along the left-right direction. The fixed display region M1 is set at a left direction upper portion position of the display region on the second display unit 26. Note that a tell-tale indicating that the a driving assistance function is in the stopped state may be configured so as not to be displayed in the fixed display region M1.

The ego vehicle region M2 is a region in the vicinity of the ego vehicle image M10. The ego vehicle region M2 is set at a central lower portion position of the display region on the second display unit 26 and at the periphery of the ego vehicle image M10. The activated tell-tale T2 is displayed looping in the ego vehicle region M2.

The vehicle display control device 10 of the present exemplary embodiment, as an example, displays the tell-tale of the second display unit 26 in a state changed from the state illustrated in FIG. 4A so as to be displayed as indicated in FIG. 4B when a fact has been acquired that the LDA function has been changed from the standby state to the activated state. Moreover, the vehicle display control device 10 displays the tell-tale of the second display unit 26 in a state changed from the state illustrated in FIG. 4B so as to be displayed as indicated in FIG. 4C when a fact has been acquired that the LDA function has changed from the activated state to the standby state.

As illustrated in FIG. 4A, the standby tell-tales T1a, T1b, T1c are displayed fixed in a row along the left-right direction in the fixed display region M1. Moreover, the standby tell-tale T1c is displayed so as to move from the fixed display region M1 to the ego vehicle region M2. The solid line arrow in FIG. 4A indicates a direction of movement and trajectory of movement of the standby tell-tale T1c.

In this manner, the standby tell-tales T1a, T1b being displayed in the fixed display region M1 accordingly indicates that the ACC and the LTA are in a standby state. Moreover, the standby tell-tale T1c being displayed in the fixed display region M1, while the standby tell-tale T1c separated therefrom is being displayed so as to move to the ego vehicle region M2, accordingly indicates that the LDA has changed from being in the standby state to being in the activated state.

As illustrated in FIG. 4B, the standby tell-tales T1a, T1b and the activated tell-tale T2c are displayed fixed in a row along the left-right direction in the fixed display region M1. The activated tell-tale T2c is displayed so as to loop above the ego vehicle image M10. The solid line arrow in FIG. 4B indicates a direction of looping and a trajectory of looping of the activated tell-tale T2c.

In this manner, switching the standby tell-tale T1c that was displayed as in FIG. 4A to display as the activated tell-tale T2c indicates that the LDA has become in the activated state. Moreover, the activated tell-tale T2c being displayed so as to loop above the ego vehicle image M10 indicates that the LDA is in the activated state.

As illustrated in FIG. 4C, the standby tell-tales T1a, T1B, T1c are displayed fixed in a row along the left-right direction in the fixed display region M1. Moreover, the standby tell-tale T1c is being displayed so as to move from the ego vehicle region M2 to the fixed display region M1. The solid arrow of FIG. 4C indicates the direction of movement and the trajectory of movement of the standby tell-tale T1c.

In this manner, switching the activated tell-tale T2c displayed as in FIG. 4B to display as the standby tell-tale T1c indicates that LDA has become in the standby state. Moreover, displaying the standby tell-tale T1c so as to move from the ego vehicle region M2 to the fixed display region M1 indicates that the LDA has changed from being in the activated state to being in the standby state.

Moreover, in the vehicle display control device 10 of the present exemplary embodiment, when there are plural driving assistance functions in the activated state, the tell-tales of the second display unit 26 are displayed in changed states as indicated in FIG. 4D.

As illustrated in FIG. 4D, the activated tell-tales T2a, T2b, and the standby tell-tale T1c ,are displayed in the fixed display region M1 fixed in a row along the left-right direction. Moreover, the activated tell-tales T2a, T2b are displayed so as to loop above the ego vehicle image M10. The solid line arrows of FIG. 4D indicate the direction of looping and the trajectory of looping of the activated tell-tales T2a, T2b.

In this manner, the activated tell-tales T2a, T2b displayed in the fixed display region M1 and displayed so as to loop above the ego vehicle image M10 thereby indicates that the ACC and the LTA are in the activated state. Moreover, the standby tell-tale T1c displayed in the fixed display region M1 indicates that the LDA is in the standby state.

Note that although in the description of FIG. 4A to FIG. 4D an example has been described of a display screen displayed on a display region on the second display unit 26, the present exemplary embodiment may be configured such that a display screen is displayed on at least one from out of the first display unit 24 or the second display unit 26. Moreover, when the display area of the first display unit 24 is narrower than the display area of the second display unit 26, a configuration may be adopted such that an image of part of the second display unit 26 is displayed on the first display unit 24.

### Flowchart

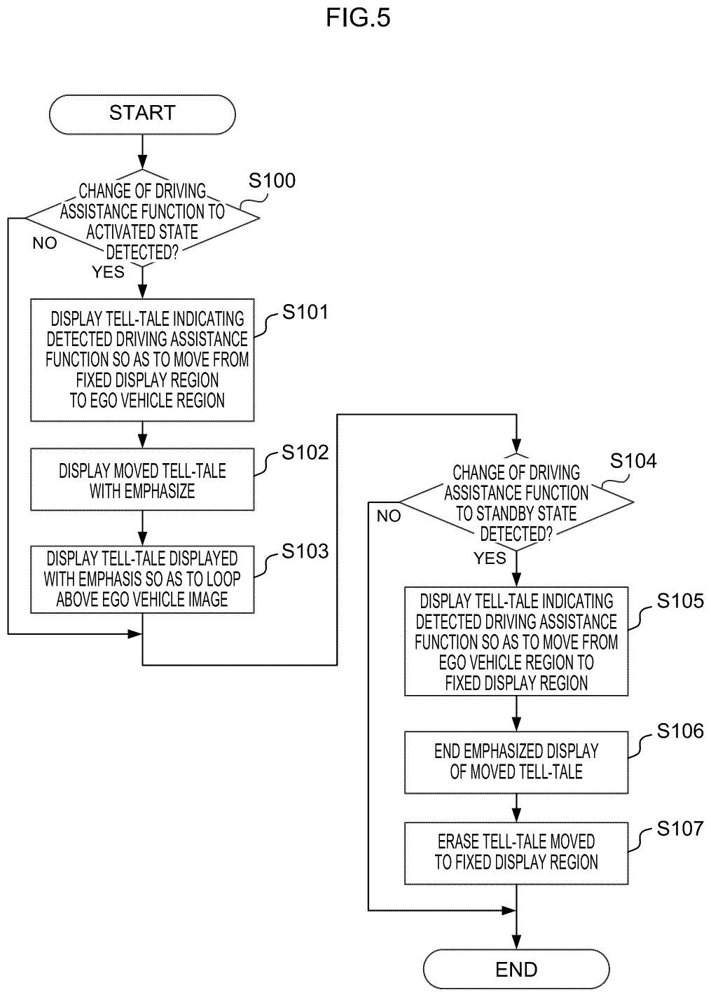

FIG. 5 is a flowchart illustrating an example of a flow of display processing according to a first exemplary embodiment. The display processing is executed by the CPU 30 of the ECU 28 reading a program from the ROM 32 or the storage 36, and expanding and executing the program in the RAM 34. The display processing is executed such that the CPU 30 functions as the functional state acquisition section 52 and the display control unit 54. The display processing illustrated in FIG. 5 is, as an example, processing repeatedly executed during travel of the vehicle 12.

At step S100 of FIG. 5, the CPU 30 determines whether or not a change to an activated state of a driving assistance function has been detected. As an example, the CPU 30 determines whether or not a change of the LDA of the vehicle 12 from a standby state to an activated state has been detected. Processing proceeds to step S101 when the CPU 30 has determined that a change to an activated state of a driving assistance function has been detected (step S100: YES). Processing proceeds to step S104 when the CPU 30 has determined that a change to an activated state of a driving assistance function has not been detected (step S100: NO).

At step S101, the CPU 30 displays a tell-tale indicating the detected driving assistance function so as to be moved from the fixed display region M1 to the ego vehicle region M2. As an example, the CPU 30 displays the standby tell-tale T1c indicating the LDA so as to be moved from the fixed display region M1 to the ego vehicle region M2 (see FIG. 4A).

At step S102, the CPU 30 displays the moved tell-tale with emphasis. As an example, when the standby tell-tale T1c indicating the LDA has moved to inside the ego vehicle region M2, the CPU 30 switches the standby tell-tale T1c to display the activated tell-tale T2c (see FIG. 4B).

At step S103, the CPU 30 displays the tell-tale displayed with emphasis so as to loop above the ego vehicle image M10. As an example, the CPU 30 displays the activated tell-tale T2c indicating LDA so as to loop above the ego vehicle image M10 (see FIG. 4B).

At step S104, the CPU 30 determines whether or not a change of a driving assistance function to a standby state has been detected. As an example, the CPU 30 determines whether or not a change of the LDA of the vehicle 12 from the activated state to the standby state has been detected. Processing proceeds to step S105 when the CPU 30 has determined that a change of a driving assistance function to the standby state has been detected (step S104: YES). However, the CPU 30 ends the display processing when determined that a change of a driving assistance function to the standby state has not been detected (step S104: NO).

At step S105, the CPU 30 displays a tell-tale indicating the detected driving assistance function so as to be moved from the ego vehicle region M2 to the fixed display region M1. As an example, the CPU 30 displays the activated tell-tale T2c indicating the LDA so as to be moved from the ego vehicle region M2 to the fixed display region M1 (see FIG. 4C).

At step S106, the CPU 30 ends emphasized display of the moved tell-tale. As an example, the CPU 30 switches the activated tell-tale T2c to displaying the standby tell-tale T1c (see FIG. 4C) when the activated tell-tale T2c indicating LDA has moved to a region outside the ego vehicle region M2.

At step S107, the CPU 30 erases the tell-tale that has moved to the fixed display region M1. As an example, the CPU 30 erases the standby tell-tale T1c indicating the LDA displayed so as to move. The CPU 30 then ends the display processing.

### First Exemplary Embodiment Summary

The vehicle display control device 10 of the first exemplary embodiment displays the ego vehicle image M10 and a tell-tale indicating the action state of a driving assistance function in the display region of the second display unit provided in the periphery of the driver's seat of the vehicle 12, and displays a tell-tale indicating this driving assistance function in a region at the periphery of the ego vehicle image M10 so as to be moved according to a change in the action state of the driving assistance function. This means that the vehicle display control device 10 of the present exemplary embodiment is able to make an occupant aware of a change to a state of an action function of the ego vehicle.

In cases in which the driving assistance function has become in the activated state, the vehicle display control device 10 of the first exemplary embodiment displays so as to move the tell-tale indicating this driving assistance function from the fixed display region M1 to the ego vehicle region M2. This means that the vehicle display control device 10 of the present exemplary embodiment is able to make an occupant more easily aware of a driving assistance function that has become in the activated state than cases in which a tell-tale indicating a driving assistance function that has become in the activated state is not displayed so as to move.

The vehicle display control device 10 of the first exemplary embodiment continuously displays the tell-tale indicating a driving assistance function in the ego vehicle region M2 while this driving assistance function is in the activated state. This means that the vehicle display control device 10 of the present exemplary embodiment is able to easily make an occupant aware of the driving assistance function that has become in the activated state by the tell-tale moved from the fixed display region M1 continuing to be displayed in the ego vehicle region M2.

The vehicle display control device 10 of the first exemplary embodiment displays a tell-tale indicating a driving assistance function that is in the activated state so as to loop above the ego vehicle image M10. This means that the vehicle display control device 10 of the present exemplary embodiment is able to even more easily make an occupant aware of each driving assistance function that is in the activated state by the tell-tale moved from the fixed display region M1 continuing to be displayed while looping above ego vehicle image M10.

In cases in which a driving assistance function has become in the standby state, the vehicle display control device 10 of the first exemplary embodiment displays a tell-tale indicating this driving assistance function so as to move from the ego vehicle region M2 to the fixed display region M1. The vehicle display control device 10 of the present exemplary embodiment is accordingly able to easily make an occupant aware of a driving assistance function that has become in the standby state by returning the tell-tale displayed in the ego vehicle region M2 when the driving assistance function is in the activated state to the fixed display region M1.

The vehicle display control device 10 of the first exemplary embodiment displays the tell-tale indicating the driving assistance function with emphasis according to the action state of the driving assistance function. This means that the vehicle display control device 10 of the present exemplary embodiment enables an occupant to discern a change in the action state of the driving assistance function from a change in the mode of the tell-tale.

### Second Exemplary Embodiment

A vehicle display control device 10 according to a second exemplary embodiment displays an activated tell-tale T2 indicating a driving assistance function of the activated state fixed to a region indicating the activated state. Description follows regarding points of difference to the first exemplary embodiment. Note that other configuration is similar to that of the above exemplary embodiment, and detailed explanation thereof will be omitted.

After the tell-tale indicating a driving assistance function has been displayed so as to move to a region in the vicinity of the ego vehicle image M10, the display control unit 54 of the second exemplary embodiment displays this tell-tale so as to be sucked into the ego vehicle image M10. While the driving assistance function indicated by this tell-tale is in the activated state, the display control unit 54 displays the tell-tale displayed so as to be sucked into the ego vehicle image M10 fixed in the region indicating the activated state. This region indicating the activated state is an example of a “region at the periphery of the ego vehicle image”.

### Display Screen

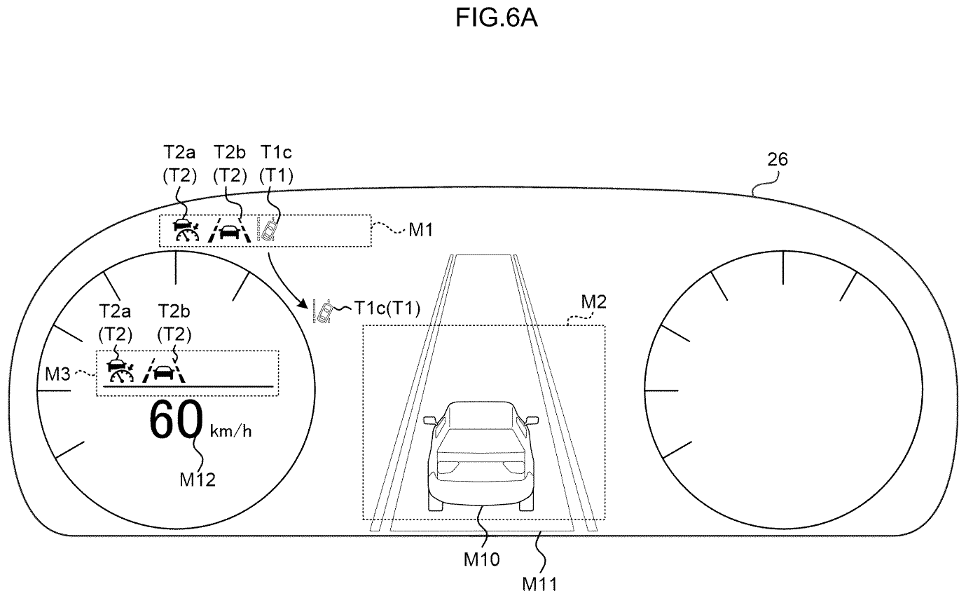

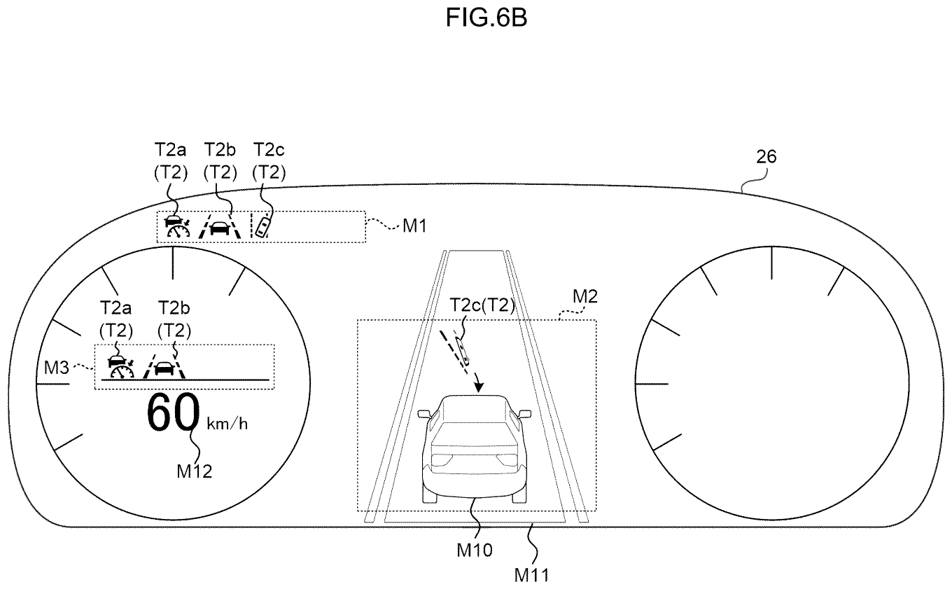

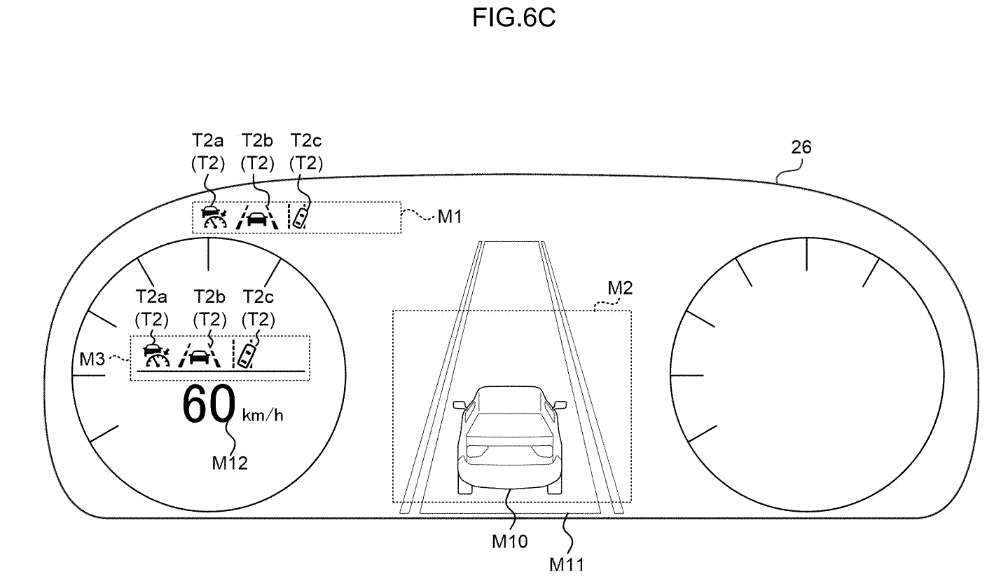

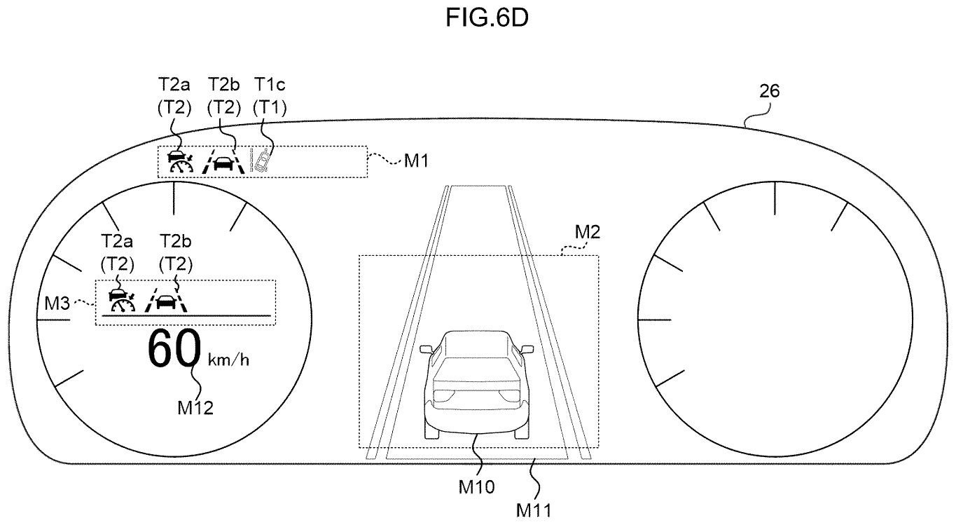

Description follows regarding part of a display screen of the second display unit 26 of the second exemplary embodiment, with reference to the flowchart of FIG. 6A to FIG. 6D. FIG. 6A to FIG. 6D are diagrams depicting changes to a tell-tale indicating an action state of a driving assistance function of the vehicle 12.

As illustrated in FIG. 6A to FIG. 6D, an activated region M3 is set on the second display unit 26 where the activated tell-tales T2 are displayable fixed. The activated region M3 is an example of a “third region”.

The activated region M3 is a region where the activated tell-tales T2 can be displayed fixed in a row along the left-right direction. The activated region M3 is set at a position above the speed display M12.

The activated tell-tales T2 of the present exemplary embodiment are, after being displayed in the ego vehicle region M2, displayed so as to be sucked into the ego vehicle image M10. The activated tell-tales T2 are erased from the ego vehicle region M2 and displayed in the activated region M3.

When the vehicle display control device 10 of the present exemplary embodiment has acquired the fact that, as an example, the LDA function has changed from the standby state to the activated state, the vehicle display control device 10 displays a tell-tale of the second display unit 26 in a changed state from the state illustrated in FIG. 6A so as to be as in FIG. 6C. When the vehicle display control device 10 has acquired the fact that the LDA function has changed from the activated state to the standby state, the vehicle display control device 10 displays the tell-tale of the second display unit 26 in a changed state from the state illustrated in FIG. 6C so as to be as in FIG. 6D.

As illustrated in FIG. 6A, the activated tell-tales T2a, T2b, and standby tell-tale T1c are displayed in the fixed display region M1 fixed in a row along the left-right direction. The activated tell-tales T2a, T2b are also displayed in the activated region M3 fixed in a row along the left-right direction. The standby tell-tale T1c is displayed so as to move from the fixed display region M1 to the ego vehicle region M2. The solid arrow of FIG. 6A indicates a direction of movement and a trajectory of movement of the standby tell-tale T1c.

In this manner, the ACC and the LTA are indicated as being in the activated state by the activated tell-tales T2a, T2b being displayed in the fixed display region M1 and in the activated region M3. The LDA is indicated as having changed from the standby state to the activated state by the standby tell-tale T1c being displayed in the fixed display region M1 while the standby tell-tale T1c separated therefrom is displayed so as to move to the ego vehicle region M2.

As illustrated in FIG. 6B, the activated tell-tales T2a, T2b, T2c are displayed in the fixed display region M1 fixed in a row along the left-right direction. The activated tell-tale T2c is displayed in the ego vehicle region M2 so as to be sucked in toward the ego vehicle image M10. The solid line arrow of FIG. 6B indicates a direction and a trajectory of sucking in of the activated tell-tale T2c.

The LDA becoming in the activated state is accordingly indicated by the standby tell-tale T1c displayed in FIG. 6A being switched to display as the activated tell-tale T2c. The LDA of the vehicle 12 is indicated as having changed from the standby state to the activated state by the activated tell-tale T2c displayed in the ego vehicle region M2 being displayed so as to be sucked into the ego vehicle image M10.

As illustrated in FIG. 6C, the activated tell-tales T2a, T2b, T2c are displayed in the fixed display region M1 fixed in a row along the left-right direction. The activated tell-tales T2a, T2b, T2c are displayed in the activated region M3.

Thus the LDA is indicated as being in the activated state by the activated tell-tale T2c displayed so as to be sucked in in FIG. 6B being erased, and the activated tell-tale T2c being displayed in the activated region M3.

As illustrated in FIG. 6D, the activated tell-tales T2a, T2b and the standby tell-tale T1c are displayed in the fixed display region M1 fixed in a row along the left-right direction. The activated tell-tales T2a, T2b are displayed in the activated region M3.

In this manner, the LTA is indicated as having transitioned from the activated state to the standby state by the activated tell-tale T2c displayed in the activated region M3 in FIG. 6C being erased, and the activated tell-tale T2c displayed in the fixed display region M1 being switched to display as the standby tell-tale T1c.

### Flowchart

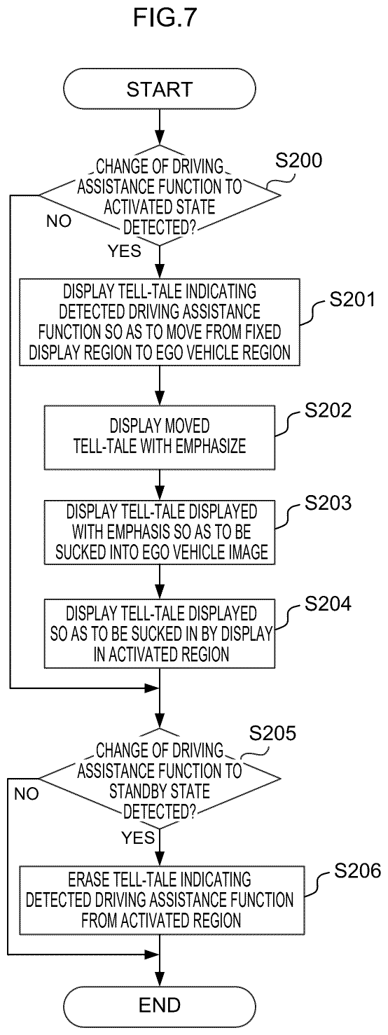

FIG. 7 is a flowchart illustrating an example of a flow of display processing according to the second exemplary embodiment.

Steps S200 to S202 of FIG. 7 are processing similar to that of steps S100 to S102 (see FIG. 5), and so detailed explanation thereof will be omitted. Note that processing proceeds to step S205 in cases in which at step S200 the CPU 30 has determined that a change to an activated state of a driving assistance function has not been detected (step S200: NO).

At step S203, the CPU 30 displays the tell-tale displayed with emphasis so as to be sucked into the ego vehicle image M10. The CPU 30, as an example, displays the activated tell-tale T2c indicating the LDA so as to be sucked into the ego vehicle image M10 (see FIG. 6B), and erases the activated tell-tale T2c from the ego vehicle region M2.

At step S204, the CPU 30 displays the tell-tale displayed so as to be sucked in by display in the activated region M3. The CPU 30, as an example, displays the activated tell-tale T2c indicating LDA fixed in the activated region M3 (see FIG. 6C).

Step S205 is processing similar to that of step S104 (see FIG. 5), and so detailed explanation thereof will be omitted. Note that the CPU 30 ends the display processing when determined that no change to a standby state of a driving assistance function has been detected (step S205: NO).

At step S206, the CPU 30 erases the tell-tale indicating the detected driving assistance function from the activated region M3. As an example, the CPU 30 erases the activated tell-tale T2c indicating the LDA from the activated region M3 (see FIG. 6D). The CPU 30 then ends the display processing.

### Second Exemplary Embodiment: Summary

The vehicle display control device 10 of the second exemplary embodiment displays the tell-tale indicating the driving assistance function so as to be sucked into the ego vehicle image M10. This means that the vehicle display control device 10 of the present exemplary embodiment is able to impart an occupant with an impression that a driving assistance function of the vehicle 12 indicated by a tell-tale has become in the activated state by displaying this tell-tale displayed so as to be sucked in associated with the ego vehicle image M10.

The vehicle display control device 10 of the second exemplary embodiment displays the tell-tale indicating this driving assistance function in the activated state fixed in the activated region M3. This means that the vehicle display control device 10 of the present exemplary embodiment is able to make an occupant aware of a list of the driving assistance functions that are in the activated state by displaying the tell-tales displayed in the ego vehicle region M2 by display fixed in the activated region M3.

### Other Exemplary Embodiments

The vehicle display control device 10 of the first exemplary embodiment acquired the action state of the driving assistance function of the vehicle 12, however the action state of the function of the vehicle 12 that the vehicle display control device 10 acquires is not limited thereto. The vehicle display control device 10 may be configured so as to acquire an action function of a warning function as the action state of the vehicle 12. A warning function is, for example, a function to display a warning to an occupant that has been determined by a safety standard, such as a hydraulic warning, a non-worn seatbelt warning, an automatic light warning, or the like. Action states include states such as a normal state in which the function is acting normally, an abnormal state in which an abnormality has arisen in the function, and an emergency state in which the function needs an emergency check. The vehicle display control device 10 displays a tell-tale indicating the warning function changed according to the action state of the warning function. This means that the vehicle display control device 10 of the present exemplary embodiment is able to display visual information to the occupant to get the occupant to understand that there is a change to the action state of the warning function of the ego vehicle. Note that warning is not limited to a warning determined by a safety standard, and may be any warning to attract the attention of the occupant.

The vehicle display control device 10 of the first exemplary embodiment continues to display the activated tell-tale T2 indicating the driving assistance function in the ego vehicle region M2 when the driving assistance function is in the activated state, however there is no limitation thereto. The vehicle display control device 10 of the present exemplary embodiment may be configured to, after displaying the activated tell-tale T2 for a specific period of time (for example, a time of 10 seconds) in the ego vehicle region M2, display so as to return to the fixed display region M1. The vehicle display control device 10 of the present exemplary embodiment is able to attract the attention of the occupant due to the tell-tale indicating that the driving assistance function is in the activated state being displayed temporarily in the ego vehicle region M2.

The vehicle display control device 10 of the first exemplary embodiment displays the activated tell-tale T2 so as to loop above the ego vehicle image M10 counterclockwise from the nearside to the far side, however the display method of the activated tell-tale T2 is not limited thereto. The vehicle display control device 10 of the present exemplary embodiment may be configured so as to display the activated tell-tale T2 with a changed height direction looping position, looping direction, or looping orientation. This means that the vehicle display control device 10 of the present exemplary embodiment is able to change a position where the activated tell-tale T2 is displayed looping so as to match variations in the display of the ego vehicle image M10 (for example vehicle model, size, or the like).

The vehicle display control device 10 of the first exemplary embodiment displays the tell-tale of the fixed display region M1 in the display region of the second display unit 26, however the display method of the tell-tale of the fixed display region M1 is not limited thereto. The vehicle display control device 10 of the present exemplary embodiment may be configured so as to display the tell-tale of the fixed display region M1 using a lamp (for example, an LED lamp, bulb lamp, or the like). The vehicle display control device 10 may, for example, illuminate the lamp of the tell-tale in white when the driving assistance function is in the activated state, and extinguish the lamp of the tell-tale when the driving assistance function is in the standby state. The vehicle display control device 10 of the present exemplary embodiment accordingly enables an occupant to be made aware of the action state of the driving assistance function from the state of the lamp of the fixed display region M1 even in cases in which a malfunction has occurred in the display region of the second display unit 26.

The vehicle display control device 10 of the second exemplary embodiment erases the activated tell-tale T2 indicating the driving assistance function from the activated region M3 when this driving assistance function changed from the activated state to the standby state, however, there is no limitation thereto. The vehicle display control device 10 of the present exemplary embodiment may be configured so as to display the activated tell-tale T2 indicating the driving assistance function so as to fly out from the ego vehicle image M10 when this driving assistance function has changed from the activated state to the standby state. The vehicle display control device 10 of the present exemplary embodiment is accordingly able to impart an impression that the driving assistance function of the vehicle 12 indicated by the tell-tale has become in the standby state by the tell-tale displayed so as to fly out and the ego vehicle image M10 being displaying associated with each other.

The vehicle display control device 10 of the second exemplary embodiment displays the tell-tale of the activated region M3 in the display region of the second display unit 26, however the display method of the tell-tale of the activated region M3 is not limited thereto. The vehicle display control device 10 of the present exemplary embodiment may be configured so as to display the tell-tale of the activated region M3 using a lamp. The vehicle display control device 10 of the present exemplary embodiment accordingly enables an occupant to be made aware of the action state of the driving assistance function from the state of the lamp of the activated region M3 even in cases in which a malfunction has occurred in the display region of the second display unit 26.

Although the first exemplary embodiment and the second exemplary embodiment have been described with examples of the driving assistance function being (1) ACC, (2) LDA, and (3) LTA, the driving assistance functions of the present exemplary embodiment are not limited thereto. For example, the following driving assistance functions are included in the driving assistance function of the present exemplary embodiment.
(4) Automatic High Beam (AHB). This function is a system that secures a distant field of view by illuminating a high beam in a normal state, and then automatically switching headlamps between high and low when an oncoming vehicle or the like has approached by detecting vehicle light ahead. A usage scenario thereof is, for example, travel at night.
(5) Emergency Driving Stop System (EDSS). This function is a function that determines whether a state of the driver is normal or abnormal, and when determined abnormal, performs in-lane emergency stop control while also performing external notification. Actionable scenarios for EDSS are expected to increase. Although EDSS has only been compatible with expressways hitherto, applicability is expected to broaden to include ordinary roads. Moreover, although EDSS has hitherto only be activated when an abnormal state of a driver has been detected during LTA operation, EDSS activation is also compatible when LTA is not being operated. Usage scenarios include, for example, during travel on ordinary roads or expressways.
(6) Lane Change Assist (LCA). In this function lane change assist is started by a turn signal being operated by a driver. This function executes steering assist and surroundings monitoring assist during lane change, and extinguishes a turn signal automatically after a lane change. Usage scenarios include, for example, during travel on an expressway.
(7) Panoramic View Monitor (PVM). This function displays a bird's-eye view on a monitor using footage captured by four cameras at the front and rear and left and right to assist in a driving scenario in which there are many blind spots. In addition, a wider array of driving scenarios is assisted by utilizing a three-dimensional footage representation (cabin interior/exterior viewpoints, a close-pass frame, an in-path obstruction frame). Interface designs are able to be engineered so as to enable viewpoint operation to be freely selected using a smart device. This thereby enables assistance with surrounding checks hitherto not possible with a conventional system. Usage scenarios include, for example, when reversing out of a parking space, reversing out of a garage, during low speed maneuvering, and the like.
(8) Advanced Park (AP). This function assists with performing automatic garage entry or assists with garage exit from a parked state by detecting a parking position using ultrasound sonar, front-rear and left-right cameras, and by a driver specifying a parking position displayed on a multimedia device. Automatic operation includes operation of the accelerator, brake, steering, and gear shift. A path storage function may also be included. A path storage function provides assistance matched to various environments by parking along a stored path. Peace of mind assistance is executed by tracing the same path as a driver. An improvement in first time usage and in continuation rate is achieved by search/detection of a recorded path, and a system providing a driver with a usage suggestion. Usage scenarios include, for example, during parking and when exiting a garage.
(9) Blind Spot Monitor (BSM)/BSM (long). This function assists surroundings safety checks during lane changes by perceiving a vehicle present in a rearward area and illuminating/flashing a door mirror indicator. Level setting is possible in BSM (long). A function of in-path obstruction warning is also envisaged. This detects bicycles, mopeds, and the like traveling at the sides of the ego vehicle, and performs an in-path obstruction warning when turning right or left. Usage scenarios include, for example, during lane changing.
(10) Advanced Drive (AD). This function is a high level driving assistance function that performs steering and acceleration/deceleration control under driver monitoring on a limited expressway (hands-off self-driving level 2 enabled). A reduction in driver burden is expected during lengthy and long-distance driving. Moreover, assistance with lane changes toward a destination is performed by overtaking and linking to a car navigation system using ego vehicle position identification at the vehicle lane level using precision mapping. Usage scenarios include, for example, during travel on a limited expressway (note that usage on general trunk roads is also envisaged in some overseas countries such as in North America).
(11) Trailer Driving Assist (T-ADAS). This function is a general term for various functions related to assistance with trailer driving. The various functions include T-DRCC, Trailer Pre-Collision System (T-PCS), T-LDA, T-BSM, Trailer Backup Guide (TBG), and T-PVM. T-DRCC adjusts to optimize acceleration/deceleration during ACC when the vehicle weight has changed during towing. T-PCS adjusts to optimize the timing of warnings and braking controls during towing when the vehicle weight has changed during towing. T-LDA is a function to suppress departure by detecting the possibility of departing from a vehicle lane/road during towing and operating the steering. T-BSM expands the detection area so as to enable detection as far as the proximity of the rear edge of a towing vehicle, reducing collision risk during lane changes. TBG implements backing assistance during trailer towing by steering assistance. T-PVM is a PVM function specifically for trailer towing or for trucks.

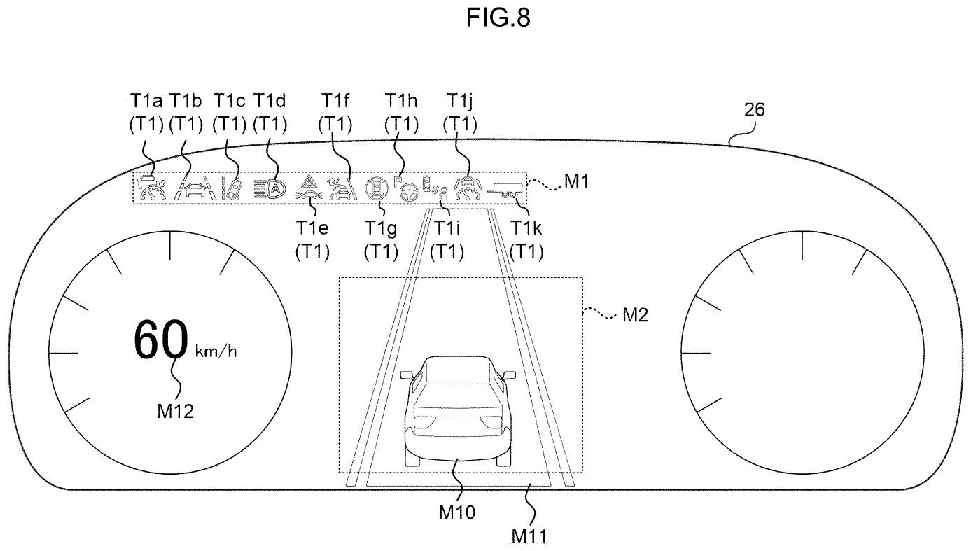

Description follows regarding display examples of the second display unit 26 when various of the above driving assistance functions are applied to the vehicle display control device 10 of the present exemplary embodiment, with reference to FIG. 8.

As illustrated in FIG. 8, a standby tell-tale T1a to a standby tell-tale T1k are displayed in the fixed display region M1. Tell-tales corresponding to the various driving assistance functions described above are employed as the tell-tales of the present exemplary embodiment. For example, the standby tell-tales T1 include a standby tell-tale T1d corresponding to AHB, a standby tell-tale T1e corresponding to EDSS, a standby tell-tale T1f corresponding to LCA, a standby tell-tale T1g corresponding to PVM, a standby tell-tale T1h corresponding to AP, a standby tell-tale T1i corresponding to BSM, a standby tell-tale T1j corresponding to AD, and a standby tell-tale T1k corresponding to T-ADAS. Activated tell-tales T2 corresponding to each of the driving assistance functions are also prepared. This means that the vehicle display control device 10 of the present exemplary embodiment displays tell-tales moved according to changes in the action state of the driving assistance function, enabling an occupant to be made aware of changes to the action state of the various driving assistance functions by switching between displaying the standby tell-tales T1 and the activated tell-tales T2.

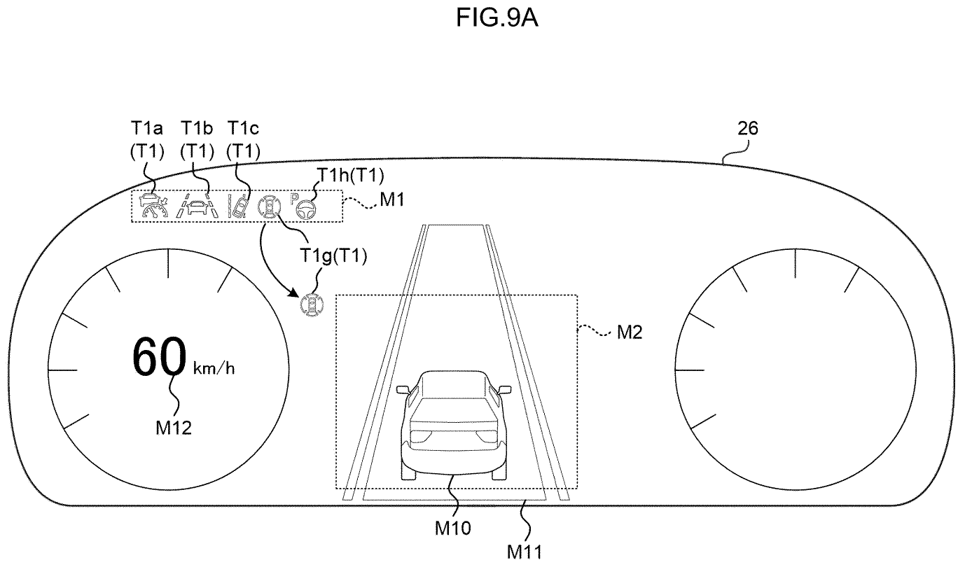

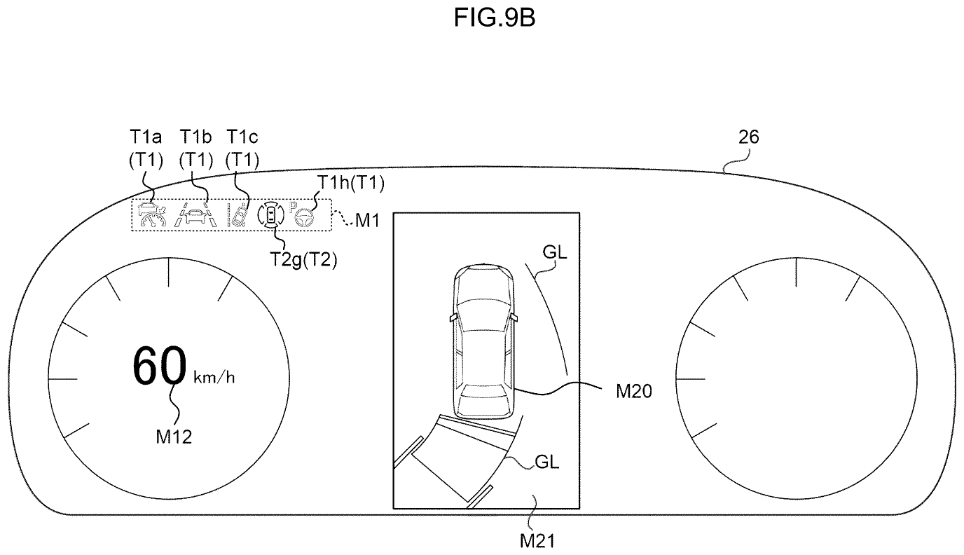

The vehicle display control device 10 of the first exemplary embodiment and the second exemplary embodiment displays the ego vehicle image M10 of the vehicle 12, depicted as viewed from diagonally above and to the rear, and the road surface image M11 at a central position on the second display unit 26, however, there is no limitation thereto. The vehicle display control device 10 of the present exemplary embodiment may be configured so as to display an ego vehicle image M20 in which the vehicle 12 is depicted as viewed from directly above and a surroundings image M21 indicating conditions in the surroundings of the vehicle 12 at a position at the center of the second display unit 26. The vehicle display control device 10 displays, for example, the ego vehicle image M20 and the surroundings image M21 on the second display unit 26 when a function such as PVM, AP, or the like is in an activated state. The surroundings image M21 is, for example, actual footage synthesized from the footage captured by the four front-rear and left-right cameras. Note that the surroundings image M21 may be an image in which conditions at the periphery of the vehicle 12 are depicted. Description follows regarding display examples displayed on the second display unit 26 when the PVM has changed from the standby state to the activated state, with reference to FIG. 9A and FIG. 9B.

Description follows regarding points of difference to FIG. 4A for the display example illustrated in FIG. 9A. Note that other configuration is similar to that of FIG. 4A as described above, and so detailed explanation thereof will be omitted.

As illustrated in FIG. 9A, the standby tell-tales T1g, T1h are displayed in the fixed display region M1 fixed in a row along the left-right direction. The standby tell-tale T1g is also displayed so as to move from the fixed display region M1 to the ego vehicle region M2. The solid line arrow of FIG. 9A indicates a direction and trajectory of movement of the standby tell-tale T1g.

This means that PVM and AP are indicated as being in the standby state by the standby tell-tales T1g, T1h being displayed in the fixed display region M1. The fact that the PVM has changed from the standby state to the activated state is indicated by the standby tell-tale T1g being displayed in the fixed display region M1, while the standby tell-tale T1g separated therefrom is displayed so as to move to the ego vehicle region M2.

As illustrated in FIG. 9B, the activated tell-tale T1g indicating that the PVM is in the activated state is displayed in the fixed display region M1. The ego vehicle image M20, the surroundings image M21, and a guide image GL indicating guide lines when reverse parking are displayed.

The fact that the PVM has become in the activated state is indicated by the standby tell-tale T1g displayed in FIG. 9A being switched to display as the activated tell-tale T2g. The fact that the PVM is in the activated state is also indicated by the ego vehicle image M10 and the road surface image M11 being switched to display as the ego vehicle image M20 and the surroundings image M21.

The vehicle display control device 10 of the present exemplary embodiment accordingly enables an occupant to be made aware of the conditions at the periphery of the vehicle 12 by displaying conditions at the periphery of the vehicle 12 as a bird's-eye view on the second display unit 26. Note that while transitioning from the display of FIG. 9A to the display of FIG. 9B, the vehicle display control device 10 of the present exemplary embodiment may be configured to display the activated tell-tale T2g so as to loop above the ego vehicle image M10, or to display the activated tell-tale T2g so as to be sucked into the ego vehicle image M10.

In addition, the configuration of the vehicle display control device 10 described in the above exemplary embodiments is merely an example thereof, and may be changed according to circumstances within a range not departing from the spirit of the present disclosure.

Moreover, a flow of processing of a program described in the above exemplary embodiments is merely an example thereof, and redundant steps may be omitted, new steps may be added, and the processing sequence may be swapped around within a range not departing from the spirit of the present disclosure.

Reference to CPU in the above exemplary embodiments indicates a widely definition of processors and, for example, encompasses general purpose processors such as a central processing unit (CPU) or the like, as well as, for example, dedicated processors such as a graphics processing unit (GPU), an application specific integrated circuit (ASIC), and programable logic devices such as a field programmable gate array (FPGA).

Moreover, an action of a processor in the above exemplary embodiments may be executed by not only a configuration of one processor, but also by a configuration in which plural processors present at different physically separated locations cooperate with each other. The sequence of actions of a processor is also not limited to only a sequence described in the above exemplary embodiments, and may be changed as appropriate.

Moreover, although a mode has been described in the above exemplary embodiment in which a program is pre-stored (installed) in storage, there is no limitation thereto. Such a program may be provided in a format recorded on a recording medium such as a compact disc read only memory (CD-ROM), digital versatile disc read only memory (DVD-ROM), universal serial bus (USB) memory, or the like. Such a program may also be a format downloaded from an external device over a network. The present disclosure is also applicable to a program product as well as a program.

An object of the technology disclosed herein is to provide a vehicle display control device, a vehicle display control method, and a vehicle display control program that are capable of making an occupant aware of changes to a state of an action function of an ego vehicle.

A first aspect of the present disclosure is a vehicle display control device that includes: a memory, and a processor coupled with the memory, the processor being configured to: display an ego vehicle image depicting an ego vehicle, and a function image indicating an action function of the ego vehicle, on a display region provided at a periphery of a driver's seat of the ego vehicle, and display the function image in a region at a periphery of the ego vehicle image so as to move based on a change to a state of the action function.

A second aspect of the present disclosure is the vehicle display control device of the first aspect, wherein: the processor is configured to, in a case in which the action function has become enabled, display so as to move the function image from a first region that is a region where the function image is displayable fixed in a case in which the action function is unavailable, to a second region that is a region in a vicinity of the ego vehicle image.

A third aspect of the present disclosure is the vehicle display control device of the second aspect, wherein: the processor is configured to continue to display the function image in the second region while the action function is enabled.

A fourth aspect of the present disclosure is the vehicle display control device of the third aspect, wherein: the processor is configured to display the function image looping at a periphery of the ego vehicle image.

A fifth aspect of the present disclosure is the vehicle display control device of the second aspect, wherein: the processor is configured to display the function image so as to be sucked into the ego vehicle image.

A sixth aspect of the present disclosure is the vehicle display control device of the second aspect, wherein: the processor is configured to display the function image in a third region that is a region where the function image is displayable fixed in a case in which the action function is enabled.

A seventh aspect of the present disclosure is the vehicle display control device of the second aspect, wherein: the processor is configured to display the function image so as to move from the second region to the first region in a case in which the action function has become unavailable.

A eighth aspect of the present disclosure is the vehicle display control device of the first aspect, wherein: the processor is configured to display a mode of the function image changed, based on a state of the action function.

A ninth aspect of the present disclosure is a vehicle display control method, that includes: by a processor, displaying an ego vehicle image depicting an ego vehicle, and a function image indicating an action function of the ego vehicle, on a display region provided at a periphery of a driver's seat of the ego vehicle; and displaying the function image in a region at a periphery of the ego vehicle image so as to move based on a change to a state of the action function.

A tenth aspect of the present disclosure is a non-transitory storing medium storing a vehicle display control program that causes a computer to execute processing that includes: displaying an ego vehicle image depicting an ego vehicle, and a function image indicating an action function of the ego vehicle, on a display region provided at a periphery of a driver's seat of the ego vehicle; and displaying the function image in a region at a periphery of the ego vehicle image so as to move based on a change to a state of the action function.

The vehicle display control device of the first aspect enables an occupant to be made aware of a change to a state of an action function of the ego vehicle by displaying the function image indicating the action function of the ego vehicle so as to move to a region at a periphery of the ego vehicle image.

The vehicle display control device of the second aspect enables an occupant to be made aware of an action function that has become enabled more easily than cases in which the function image indicating an action function that has become enabled is not displayed so as to move.

The vehicle display control device of the third aspect enables an occupant to be made aware of an action function that is enabled more easily than cases in which the function image moved from the first region does not continue to be displayed in the vicinity of the ego vehicle image.

The vehicle display control device of the fourth aspect enables an occupant to be made aware of each action function is enabled more easily due to the function image moved from the first region continuing to be displayed looping at a periphery of the ego vehicle image.

The vehicle display control device of the fifth aspect enables an occupant to be imparted with an impression that the action function of the ego vehicle indicated by the function image has become enabled due to the function image displayed so as to be sucked in being displayed associated with the ego vehicle.

The vehicle display control device of the sixth aspect enables an occupant to be made aware of a list of enabled action functions by the function image displayed in the vicinity of the ego vehicle image being fixed in the third region.

The vehicle display control device of the seventh aspect enables an occupant to be made aware of an action function that has become unavailable easily by the function image displayed in the vicinity of the ego vehicle image when the action function is enabled being returned to the first region.

The vehicle display control device of the eighth aspect enables an occupant to discern a change of state of an action function from a change to the mode of the function image.

The vehicle display control method of the ninth aspect enables an occupant to be made aware of a change to a state of an action function of the ego vehicle.

The vehicle display control program of the tenth aspect enables an occupant to be made aware of a change to a state of an action function of the ego vehicle.

Technology disclosed herein enables an occupant to be made aware of a change to a state of an action function of the ego vehicle.

What is claimed is:

1. A vehicle display control device comprising:
a memory, and
a processor coupled with the memory, the processor being configured to:
display an ego vehicle image depicting an ego vehicle, and a function image indicating an action function of the ego vehicle, on a display region provided at a periphery of a driver's seat of the ego vehicle, and
display the function image in a region at a periphery of the ego vehicle image so as to move based on a change to a state of the action function.

2. The vehicle display control device of claim 1, wherein:
the processor is configured to, in a case in which the action function has become enabled, display so as to move the function image from a first region that is a region where the function image is displayable fixed in a case in which the action function is unavailable, to a second region that is a region in a vicinity of the ego vehicle image.

3. The vehicle display control device of claim 2, wherein:
the processor is configured to continue to display the function image in the second region while the action function is enabled.

4. The vehicle display control device of claim 3, wherein:
the processor is configured to display the function image looping at a periphery of the ego vehicle image.

5. The vehicle display control device of claim 2, wherein:
the processor is configured to display the function image so as to be sucked into the ego vehicle image.

6. The vehicle display control device of claim 2, wherein:
the processor is configured to display the function image in a third region that is a region where the function image is displayable fixed in a case in which the action function is enabled.

7. The vehicle display control device of claim 2, wherein:
the processor is configured to display the function image so as to move from the second region to the first region in a case in which the action function has become unavailable.

8. The vehicle display control device of claim 1, wherein:
the processor is configured to display a mode of the function image changed, based on a state of the action function.

9. A vehicle display control method, comprising:
by a processor,
displaying an ego vehicle image depicting an ego vehicle, and a function image indicating an action function of the ego vehicle, on a display region provided at a periphery of a driver's seat of the ego vehicle; and
displaying the function image in a region at a periphery of the ego vehicle image so as to move based on a change to a state of the action function.

10. A non-transitory storing medium storing a vehicle display control program that causes a computer to execute processing comprising:
displaying an ego vehicle image depicting an ego vehicle, and a function image indicating an action function of the ego vehicle, on a display region provided at a periphery of a driver's seat of the ego vehicle; and
displaying the function image in a region at a periphery of the ego vehicle image so as to move based on a change to a state of the action function.
